(19) United States
(12) Patent Application Publication
(10) Pub. No.: US 2023/0219550 A1
(43) Pub. Date: Jul. 13, 2023

(54) ELECTRIC PARKING BRAKE DEVICE FOR VEHICLE

(71) Applicant: ADVICS CO., LTD., Kariya-shi, Aichi-ken (JP)

(72) Inventors: Masaya KOTANI, Kariya-shi, Aichi-ken (JP); Kentaro YUASA, Kariya-shi, Aichi-ken (JP); Daisuke SATO, Kariya-shi, Aichi-ken (JP)

(73) Assignee: ADVICS CO., LTD., Kariya-shi, Aichi-ken (JP)

(21) Appl. No.: 17/996,713

(22) PCT Filed: Apr. 29, 2021
(86) PCT No.: PCT/JP2021/017131

§ 371 Date: Oct. 20, 2022

(30) Foreign Application Priority Data
Apr. 30, 2020 (JP) 2020-079922

(51) Int. Cl. B60T 13/74; B60T 17/22

(52) U.S. Cl. CPC B60T 13/741; B60T 17/22

(57) ABSTRACT

An electric parking brake device includes: a “linear motion member configured to be driven by an electric motor, moved in a forward direction so as to apply a parking brake and moved in a backward direction opposite to the forward direction so as to release the parking brake”; and a “controller configured to control the electric motor”. When the parking brake is released, the controller stops energization to the electric motor at a time point when a first predetermined time elapses after a time point when an energization amount to the electric motor becomes constant.

### TECHNICAL FIELD

The disclosure relates to an electric parking brake device for a vehicle.

### BACKGROUND ART

PTL 1 relates to an electric parking brake device configured such that a parking lever in a drum brake is driven from a return position to an operating position by forward driving of an electric actuator so as to drive a brake shoe from a return position to an operating position, and the parking lever is driven from the operating position to the return position by reverse driving of the electric actuator so as to drive the brake shoe from the operating position to the return position. For the purpose of “preventing insufficient return or excessive return of the parking lever when a parking brake is released”, “the electric actuator includes: an electric motor that can perform forward and reverse rotation driving and whose operation is controlled by a motor control unit according to a rotational load; a conversion mechanism capable of converting a rotational motion into a linear motion, capable of moving the parking lever from the return position to the operating position during forward driving in which the electric motor rotates forwardly, and capable of moving the parking lever from the operating position to the return position during reverse driving in which the electric motor rotates reversely; and a load applying mechanism that drives a component of the conversion mechanism to apply a rotational load, which increases according to a driving amount of the component, to the electric motor after the parking lever is moved from the operating position to the return position by reverse rotation of the electric motor, and the motor control unit includes: a calculation unit configured to calculate, based on a current supplied to the electric motor, a rotational load determination value for determining whether or not the rotational load applied to the electric motor by the load applying mechanism during reverse rotation driving of the electric motor is equal to or larger than a set value; and a reverse rotation driving stopping unit configured to stop the reverse rotation driving of the electric motor when it is determined that the rotational load determination value is equal to or larger than a reference value after a set time elapses after the reverse rotation driving of the electric motor is started”.

Specifically, the device of PTL 1 includes a stopper 277 and a disc spring assembly 28 that function as the load applying mechanism. After a parking lever 17 moves from the operating position to the return position, the stopper 27 engages with a first connection pin 29a of a connection mechanism 29, and thus axial movement of a rod 22e in a return direction is restricted. When it is determined that the rotational load determination value (current value A) is equal to or larger than the reference value (Ao+A3) after the set time elapses (T≥T5) after reverse rotation driving of an electric motor 21 is started (T=0), the reverse rotation driving of the electric motor 21 is stopped. Accordingly, the reverse rotation driving of the electric motor 21 can be reliably stopped, and the rotational load required to be applied by the load applying mechanism (the stopper 27 and the disc spring assembly 28) can be set to be small.

In the electric parking brake device according to PTL 1, at the return position that corresponds to a released state of the parking brake, the rod is abutted against the stopper or the like, and thus movement of the rod is restricted. That is, a screw mechanism is in a tightened state (also referred to as a “restrained state”) to a certain extent. Therefore, in a case where a parking brake instruction is issued in a state in which the parking lever stands by at the return position, it is necessary to supply predetermined electric power to the electric motor in order to release the tightening when moving the parking lever toward the operating position. In the electric parking brake device, it is desired to reduce such electric power.

### CITATION LIST

### Patent Literature

PTL 1: JP-A-2016-43798

### SUMMARY

### Technical Problem

An object of the disclosure is to provide an electric parking brake device capable of reducing power consumption of an electric motor when a parking brake instruction is issued.

### Solution to Problem

An electric parking brake device (EP) according to the disclosure includes: a “linear motion member (TD) configured to be driven by an electric motor (MT), moved in a forward direction (Ha) so as to apply a parking brake and moved in a backward direction (Hb) opposite to the forward direction (Ha) so as to release the parking brake”; and a “controller (ECU) configured to control the electric motor (MT)”. When the parking brake is released, the controller (ECU) stops energization to the electric motor (MT) at a time point (t4) when a first predetermined time (tx1) elapses after a time point (t3) when an energization amount (Ia) to the electric motor (MT) becomes constant.

According to the above configuration, since the electric motor MT and the members (the linear motion member TD and the like) driven by the electric motor MT are in an unrestrained state (a state of not being restrained, a free state) in the state in which the parking brake is released, no power supply is required to release the tightening described above. Therefore, when a parking brake instruction is issued, power consumption of the electric motor can be reduced. In addition, since components such as a stopper and the like are not required, a size and a weight of the device can be reduced.

### BRIEF DESCRIPTION OF DRAWINGS

FIG. 1 is a schematic diagram showing a braking device DB.

FIG. 2 is a schematic diagram showing an electric parking brake device EP.

FIG. 3 is a flowchart showing a first processing example of release control.

FIG. 4 is a time series diagram showing operations of the first processing example.

FIG. 5 is a flowchart showing a second processing example of the release control.

FIG. 6 is a time series diagram showing operations of the second processing example.

### DESCRIPTION OF EMBODIMENTS

### <Braking Device DB>

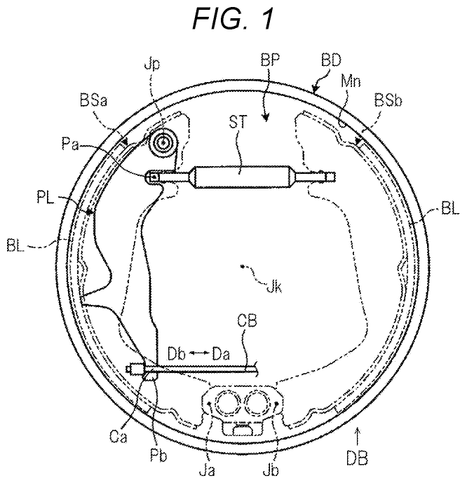

A braking device DB that generates a braking force on a wheel (for example, a rear wheel) of a vehicle will be described with reference to a schematic diagram of FIG. 1. The braking device DB generates the braking force on the wheel by applying a braking torque to the wheel. For example, a known drum brake is adopted as the braking device DB. In the following description, components, elements, signals, characteristics, and the like denoted by the same reference numerals such as “MT” have the same functions.

The braking device DB is provided on the wheel. A braking force that decelerates the vehicle (referred to as a “deceleration braking force Fx”) and a braking force that maintains a stopped state of the vehicle (referred to as a “parking braking force Fp”) are generated by the braking device DB. The deceleration braking force Fx is generated by using a pressure (hydraulic pressure) of a brake fluid in a wheel cylinder (not shown) as a power source. In addition, the parking braking force Fp is generated by using an electric actuator (also simply referred to as an “actuator”) DN as a power source. The deceleration braking force Fx is used for a service brake, and the parking braking force Fp is used for a parking brake.

### <<Operation of Service Brake>>

The braking device DB includes a brake drum BD, brake shoes BSa and BSb, the wheel cylinder (not shown), and a backing plate BP so as to generate the deceleration braking force Fx.

In the braking device DB, the brake drum BD is fixed to the wheel so as to rotate integrally with the wheel about a rotation axis Jk of the wheel. The braking device DB includes the two brake shoes BSa and BSb. The two brake shoes BSa and BSb are extended in an arc shape along an inner circumferential surface Mn of the cylindrical brake drum BD. Brake linings BL (friction materials) are baked onto the brake shoes BSa and BSb. The braking device DB includes the disc-shaped backing plate BP. The wheel cylinder (not shown), the brake shoes BSa and BSb, and the like are disposed outward of the backing plate BP in a vehicle width direction.

The two brake shoes BSa and BSb are pressed against the inner circumferential surface Mn of the brake drum BD by the wheel cylinder. Accordingly, a braking torque is applied to the brake drum BD by friction between the brake linings BL provided on the brake shoes BSa and BSb and the brake drum BD (in particular, the inner circumferential surface Mn), and as a result, the wheel generates the braking force Fx. That is, the wheel cylinder is used for vehicle deceleration during traveling.

Specifically, lower end portions of the brake shoes BSa and BSb are supported by the backing plate BP so as to be rotatable about two rotation positions Ja and Jb. The wheel cylinder is supported by an upper end portion of the backing plate BP. The wheel cylinder includes two movable portions (pistons) that can protrude in a vehicle front-rear direction, and the movable portions are protruded by the pressure of the brake fluid in the wheel cylinder. Due to the protrusion of the movable portions, upper end portions of the brake shoes BSa and BSb are pressed, and the brake linings BL are pressed against the inner circumferential surface Mn of the brake drum BD. A braking torque is applied to the brake drum BD by friction between the brake linings BL and the inner circumferential surface Mn, and thus the wheel is braked.

The braking device DB is provided with a return member (for example, a coil spring) that is not shown. When the pressing on the brake shoes BSa and BSb is released by the return member, the brake shoes BSa and BSb are moved so as to be separated from the inner circumferential surface Mn of the brake drum BD.

### <<Operation of Parking Brake>>

The braking device DB includes the electric actuator DN, a parking lever PL, a parking cable CB, and a shoe strut ST in addition to the above-described components (the brake drum BD and the like) so as to generate the parking braking force Fp.

The electric actuator DN serves as an actuator that drives the brake shoes BSa and BSb, and is used for braking at the time of parking. Specifically, the two brake shoes BSa and BSb are moved so as to generate the parking braking force Fp by the electric actuator DN (also simply referred to as an “actuator”) driven by an electric motor MT. Details of the actuator DN will be described later. The actuator DN may also be used for braking during traveling (that is, service braking).

The parking lever PL is provided between one of the two brake shoes BSa and BSb (for example, the brake shoe BSa) and the backing plate BP so as to overlap the brake shoe BSa and the backing plate BP. The parking lever PL is supported by the brake shoe BSa so as to be rotatable about a rotation axis Jp. The parking cable CB is connected to a lower end portion Pb, which is located on a side far from the rotation axis Jp, of the parking lever PL.

The shoe strut ST is provided between the two brake shoes BSa and BSb. When the parking brake is applied, the parking cable CB is pulled by the actuator DN. Accordingly, the parking lever PL is moved in an application direction Da (a direction in which the parking braking force Fp increases). At this time, since the parking lever PL tends to rotate about the rotation axis Jp, the shoe strut ST is propped between the two brake shoes BSa and BSb. One brake shoe BSb is pushed due to propping of the shoe strut ST, and the other brake shoe BSa is pushed by a reaction force of the shoe BSb. As a result, the brake linings BL of the brake shoes BSa and BSb are pressed against the inner circumferential surface Mn of the brake drum BD, and thus the parking braking force Fp is generated.

When the parking brake is released, a tension of the parking cable CB is reduced by the actuator DN. Accordingly, the parking lever PL is moved in a release direction Db (a direction in which the parking braking force Fp decreases). A pressing force of the brake linings BL against the inner circumferential surface Mn of the brake drum BD is reduced. Then, the inner circumferential surface Mn of the brake drum BD and the brake linings BL are finally separated from each other by the return member.

The braking device DB is described above, and more details thereof are described in “JP-A-2019-116965”.

### <Electric Parking Brake Device EP>

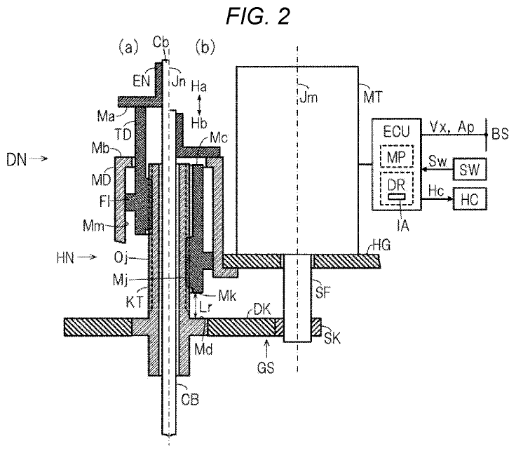

An embodiment of an electric parking brake device EP according to the disclosure will be described with reference to a schematic diagram including a partial cross-sectional view of FIG. 2. A vehicle including the electric parking brake device EP is provided with a parking brake switch (also simply referred to as a “parking switch”) SW. The parking switch SW is a switch operated by a driver, and an ON or OFF signal Sw (referred to as a “parking signal”) is output to an electronic control unit ECU (also referred to as a “controller”). That is, an operation (application operation or release operation) of a parking brake that maintains a stopped state of the vehicle is instructed by the parking switch SW operated by the driver. Specifically, when the parking signal Sw is in an ON state (ON), the application (operation) of the parking brake is instructed such that the parking brake is effective. On the other hand, when the parking signal Sw is in an OFF state (OFF), the release (operation) of the parking brake is instructed such that the parking brake is not effective.

The vehicle includes a plurality of controllers (electronic control units). These controllers are connected by a communication bus BS such that signals (detection values, calculations, and the like) are shared. For example, a vehicle body speed Vx and an operation amount Ap of an acceleration operation member (for example, an accelerator pedal) are input to the controller ECU from the communication bus BS. The vehicle body speed Vx and the acceleration operation amount Ap are used in an automatic mode of the electric parking brake device EP, which will be described later. Although parking brake control including release control is calculated by the controller ECU in the following description, processing of the parking brake control (application control, release control) may be performed by another controller, and an instruction may be issued to the controller ECU via the communication bus BS.

The vehicle includes a notification unit HC. The notification unit HC notifies the driver of an abnormal state of the electric parking brake device EP. The notification unit HC visually (for example, by turning on an indicator) or audibly (for example, by a notification sound) notifies the driver based on a notification signal Hc from the controller ECU.

The electric parking brake device EP is implemented by the actuator DN and the controller ECU. The actuator DN generates the parking braking force Fp by the electric motor MT. Details of the electric actuator DN are described in “JP-A-2019-116965”, similarly to those of the braking device DB. Hereinafter, the actuator DN will be briefly described. A characteristic portion of the electric parking brake device EP according to the disclosure is a control algorithm programmed in the controller ECU.

### <<Electric Actuator DN>>

The electric actuator DN is fixed to an inner side surface of the backing plate BP in the vehicle width direction on a side opposite to the brake shoes BSa and BSb with respect to the backing plate BP. The parking cable CB is extended from the actuator DN. The parking cable CB passes through a through hole provided in the backing plate BP and is connected to the parking lever PL (particularly, the lower end portion Pb).

The actuator DN includes a housing HG, an electric motor MT, a speed reducer GS, a motion conversion mechanism HN, the parking cable CB, and an end member EN. The housing HG supports the electric motor MT, the speed reducer GS, and the motion conversion mechanism HN, and covers these components. The electric motor MT is a power source for generating the parking braking force Fp. The electric motor MT is driven by the controller ECU.

The speed reducer GS includes a plurality of gears. For example, the speed reducer GS includes a large diameter gear DK and a small diameter gear SK. The small diameter gear SK is fixed to an output shaft SF of the electric motor MT. The large diameter gear DK meshes with the small diameter gear SK. An output of the electric motor MT (that is, rotational power of the output shaft SF) is decelerated via the speed reducer GS. The decelerated rotational power of the electric motor MT is input to the motion conversion mechanism HN.

The motion conversion mechanism HN includes a rotary member KT, a linear motion member TD, and a rotation stopping member MD. The large diameter gear DK is fixed to the rotary member KT. Therefore, the rotary member KT is driven to rotate integrally with the large diameter gear DK. The rotary member KT has a cylindrical shape, and a male screw Oj is formed on an outer circumferential portion thereof. The rotary member KT is a “bolt member”.

The male screw Oj of the rotary member KT is screwed into a female screw Mj of the linear motion member TD. Specifically, the linear motion member TD has a tubular shape, and the female screw Mj is formed in an inner circumferential portion thereof (inside a through hole). The linear motion member TD is a “nut member”. In the motion conversion mechanism HN, the rotary member KT (bolt member) and the linear motion member TD (nut member) are meshed with each other, and thus rotational power of the electric motor MT is converted into linear power. Here, as the motion conversion mechanism HN, a mechanism that performs self-locking (a mechanism in which reverse efficiency is zero) is adopted.

A rotational motion of the linear motion member TD is restricted by the rotation stopping member MD. That is, rotation of the linear motion member TD is stopped by the rotation stopping member MD, and thus a linear movement of the linear motion member TD is guided. For example, a flange portion F1 is provided on an outer circumferential portion of the linear motion member TD, and at least one double chamfer is formed on the flange portion F1. The rotation stopping member MD has a tubular shape, and an inner surface thereof is processed so as to be fittable to the double chamfer of the flange portion F1. The double-chamfered portion (flat surface) of the flange portion F1 and a double-chamfered portion (flat surface) of the rotation stopping member MD slide on each other, so that the rotational motion of the linear motion member TD is restricted. Accordingly, the rotation stopping member MD is linearly moved along a rotation axis Jn of the rotary member KT. An end surface Mb is formed on the rotation stopping member MD on a side opposite to a side on which the large diameter gear DK is fixed.

The parking cable CB passes through an inner circumferential surface (through hole) of the rotary member KT and extends in the direction of the rotation axis Jn. One end of the parking cable CB is coupled to the parking lever PL, which is a movable member, so as to actuate the brake shoes BSa and BSb. The end member EN is coupled to the other end of the parking cable CB. The end member EN includes a tubular portion and a flange portion. When the tubular portion of the end member EN is crimped from the outside, the parking cable CB and the end member EN are joined (fixed) to each other. The flange portion (in particular, an end surface Ma) of the end member EN protrudes outward in a radial direction relative to an end portion Mc of the linear motion member TD, and can be abutted against the end portion Mc. In addition, the flange portion (in particular, the end surface Ma) can be abutted against the end surface Mb of the rotation stopping member MD.

In FIG. 2, a state (a) shown on a left side with respect to the rotation axis Jn (dash-dotted line) of the rotary member KT shows a state in which the electric motor MT is driven and a tension is applied to the parking cable CB. In the state (a), the brake shoes BSa and BSb are pressed against the brake drum BD, and the wheel is restrained by the electric parking brake device EP (that is, the parking braking force Fp is applied to the wheel). This state (a) is referred to as an “application state”, and is a state in which the parking brake is applied.

In FIG. 2, a state (b) shown on a right side with respect to the rotation axis Jn of the rotary member KT shows a state in which the tension applied to the parking cable CB is released. Here, the end member EN and the linear motion member TD are not integrated with each other, and are configured to be separable from each other in an axial direction. In the state (b), the brake shoes BSa and BSb are separated from the brake drum BD, and the parking braking force Fp does not act on the wheel. This state (b) is referred to as a “release state”, and is a state in which the parking brake is not applied.

### <<Controller ECU>>

The controller ECU (electronic control unit) controls the electric motor MT to drive the actuator DN. The controller ECU includes an electric circuit board on which a microprocessor MP and the like are installed, and a control algorithm programmed in the microprocessor MP. A drive signal Mt for controlling the electric motor MT is calculated based on the control algorithm in the microprocessor MP. In addition, the controller ECU includes a drive circuit DR that drives the electric motor MT. In the drive circuit DR, a bridge circuit is formed by switching elements (power semiconductor devices such as MOS-FETs and IGBTs). An energization state of each switching element is controlled according to the drive signal Mt, and thus the output of the electric motor MT is controlled. The drive circuit DR includes an energization amount sensor IA that detects an actual energization amount Ia of the electric motor MT. For example, a current sensor is adopted as the energization amount sensor IA, and the current Ia supplied to the electric motor MT is detected.

The application operation of the parking brake (that is, transitioning from the release state (b) to the application state (a) such that the parking brake is applied) will be described. Control of the actuator DN when the parking brake is applied is referred to as “application control”. When the parking switch SW is operated and the parking signal Sw is switched from OFF to ON, energization to the electric motor MT is started. The electric motor MT is driven to rotate in a forward rotation direction, and rotational power thereof is transmitted to the rotary member KT via the speed reducer GS. The rotational power of the rotary member KT is converted into linear power of the linear motion member TD. Here, the linear motion member TD is guided by the rotation stopping member MD (in particular, the double-chamfered portion of the flange portion F1 and the inner circumferential portion Mm) to move along the rotation axis Jn (movement in a forward direction Ha). The forward direction Ha of the linear motion member TD corresponds to the forward rotation direction of the electric motor MT and the application direction Da of the parking lever PL. In a state in which the end portion Mc of the rotary member KT and the end surface Ma of the end member EN are not abutted against each other, no tension is applied to the parking cable CB. Therefore, in the electric motor MT, an output is generated according to a frictional force (sliding friction) in response to movement of the rotary member KT, the linear motion member TD, the rotation stopping member MD, and the like.

Since the parking cable CB and the end member EN are fixed to each other, when the end portion Mc of the rotary member KT and the end surface Ma of the end member EN are abutted against each other, a tension is generated on the parking cable CB. When the end member EN is moved in the forward direction Ha, the tension of the parking cable CB is increased, and the lower end portion Pb of the parking lever PL is moved in the application direction Da. Accordingly, a pressing force of the brake linings BL against the brake drum BD is increased, and thus the parking braking force Fp is increased. Since a torque output of the electric motor MT is substantially proportional to the energization amount Ia, energization to the electric motor MT is stopped at a time point when the energization amount Ia reaches an application amount iz. Here, the application amount iz is a predetermined value (constant) set in advance. Since the motion conversion mechanism HN is self-locked, even when the electric motor MT is not energized, the tension of the parking cable CB is maintained, and the state in which the parking brake is applied (that is, the application state) is maintained.

Next, the release operation of the parking brake (that is, transitioning from the application state (a) to the release state (b) such that the parking brake is not applied) will be described. Control of the actuator DN when the parking brake is released is referred to as “release control”. When the parking switch SW is operated and the parking signal Sw is switched from ON to OFF, energization to the electric motor MT is started. The electric motor MT is driven to rotate in a reverse rotation direction. The linear motion member TD is moved in a backward direction Hb by the rotational power of the electric motor MT. Accordingly, the tension on the parking cable CB is reduced, and the parking braking force Fp is reduced. Then the end surface Ma of the end member EN is abutted against the end portion Mb of the rotation stopping member MD. So far, the end member EN and the linear motion member TD are integrally moved. The backward direction Hb of the linear motion member TD corresponds to the reverse rotation direction of the electric motor MT and the release direction Db of the parking lever PL.

Further, when the electric motor MT is driven in the reverse rotation direction, the end member EN and the linear motion member TD are separated from each other. Accordingly, the tension on the parking cable CB is substantially zero. Thereafter, the electric motor MT is driven in the reverse rotation direction based on a time. In a state in which there is a certain distance (that is, a gap Lr) between an end portion Mk (on a side opposite to the end portion Mc) of the linear motion member TD and the portion Md of the rotary member KT, the energization to the electric motor MT is stopped, and the movement of the linear motion member TD in the backward direction Hb is stopped. In other words, when the movement of the linear motion member TD is stopped, there is a gap between the end portion Mk of the linear motion member TD and the portion Md of the rotary member KT, and a stopper or the like is not necessary.

### <First Processing Example of Release Control>

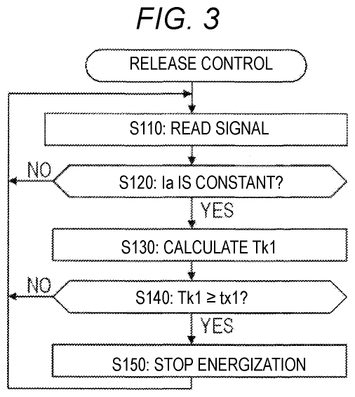

A first processing example of the release control will be described with reference to a flowchart of FIG. 3. Here, the “release control” is drive control of the electric motor MT for causing the parking brake to transition from the application state in which the parking brake is applied to the release state in which the parking brake is not applied (that is, for releasing the parking brake). The release control is started at a time point when the parking signal Sw is switched from ON to OFF. In the release control, the electric motor MT is energized (for example, a negative voltage is applied), and the electric motor MT is driven in the reverse rotation direction.

In step S110, various signals including the actual energization amount Ia are read. For example, the energization amount Ia (actual value) is detected by an energization amount sensor IA provided in the drive circuit DR. In addition, the energization amount sensor IA may be incorporated in the electric motor MT.

In step S120, it is determined “whether or not the energization amount Ia to the electric motor MT is constant”. This determination is to determine that the energization amount Ia is in a constant state, and is referred to as “constant determination”. For example, the constant state of the energization amount Ia is determined at a time point when a state in which the energization amount Ia falls within a predetermined range (a range of a determination amount ih) set in advance is continued for a predetermined time th (referred to as a “determination time”). In addition, the constant state of the energization amount Ia may be determined at a time point when a state in which a change amount dI of the energization amount Ia relative to a time T is equal to or smaller than a determination change amount dx is maintained over the determination time th. Here, the determination amount ih, the determination time th, and the determination change amount dx are predetermined values (constants) set in advance.

The state in which the energization amount Ia is constant corresponds to “a state in which the tension on the parking cable CB is substantially zero, and the brake linings BL (friction materials) and the brake drum DB (a wheel member that rotates integrally with the wheel, and a member that is in contact with the friction materials) are not substantially in contact with each other”. Therefore, the energization amount Ia supplied in the constant state corresponds to a value caused by friction (sliding friction) between the electric motor MT (a bearing and the like) and power transmission members (the speed reducer GS, the motion conversion mechanism HN, and the like).

In order to improve robustness of the constant determination, “the energization amount Ia is less than a release amount ix” may be added to conditions of the constant determination as a permission condition. For example, in a case where transmission efficiency of the power transmission members (the speed reducer GS, the motion conversion mechanism HN, and the like) decreases, a decrease amount (referred to as a “decrease gradient”) of the energization amount Ia with respect to the time T decreases, and the constant state of the energization amount Ia may be determined even in a state in which the brake linings BL are still in contact with the brake drum BD. Therefore, in a state of “Ia≥ix”, execution of the constant determination is prohibited, and the execution of the constant determination is permitted only in a state of “Ia<ix”. Here, the release amount ix is a predetermined value (constant) set in advance. The release amount ix is set to a value slightly larger than an energization amount corresponding to a case where the electric motor MT is driven with no load in a normal state (at a normal temperature) (that is, sliding friction of the electric motor MT, the speed reducer GS, the rotary member KT, the linear motion member TD, the rotation stopping member MD, and the like).

When the determination of “the energization amount Ia is constant” is negative in step S120, the process returns to step S110. On the other hand, when the determination of “the energization amount Ia is constant” is affirmative, the process proceeds to step S130.

In step S130, a first duration time Tk1 is calculated. The first duration time Tk1 is a time from a time point (corresponding calculation cycle) when the determination in step S120 is affirmative for the first time. In other words, the first duration time Tk1 is a time elapses after a time point when a state in which the energization amount Ia is not constant is switched (transitioned) to a state in which the energization amount Ia is constant.

In step S140, it is determined “whether or not the first duration time Tk1 is equal to or longer than a first predetermined time tx1”. Here, the first predetermined time tx1 is a predetermined value (constant) set in advance. When “Tk1<tx1” and the determination in step S140 is negative, the process returns to step S110. On the other hand, when “Tk1≥tx1” and the determination in step S140 is affirmative, the process proceeds to step S150.

In step S150, application of a voltage to the electric motor MT is stopped, and the energization is stopped. That is, in step S150, the release control is ended.

As described above, according to the electric parking brake device EP, when the parking brake is released, the energization to the electric motor MT is stopped at the time point (corresponding calculation cycle) when the first predetermined time tx1 elapses after the time point when the energization amount Ia to the electric motor MT is constant. Accordingly, the movement of the linear motion member TD in the backward direction Hb is ended, and the linear motion member TD stops. At this time, the end portion Mk of the linear motion member TD and the portion Md of the rotary member KT have the gap Lr therebetween and are not in contact with each other. In other words, since the release control of the electric parking brake device EP is performed according to the time T, it is not necessary to restrict the movement of the linear motion member TD in the backward direction Hb by abutment against a movement restricting member such as a stopper.

Therefore, in a state in which the electric parking brake device EP is released, the electric motor MT and the members (the linear motion member TD, the rotary member KT, and the like) driven by the electric motor MT are each in an unrestrained state (free state). Specifically, in a state in which the parking brake is released (that is, a state in which the parking brake is not applied), the male screw Oj and the female screw Mj of the motion conversion mechanism HN are not tightened. Therefore, when a parking brake instruction is issued again and the application control of the electric parking brake device EP is started, it is not necessary to supply electric power for releasing (canceling) the tightening, and thus the electric power of the electric motor MT can be reduced. Therefore, in the electric parking brake device EP according to the disclosure, power saving of the device is achieved. Further, since the movement restricting member for the linear motion member TD can be omitted, a size and a weight of the device can be reduced.

### <Operations of First Processing Example>

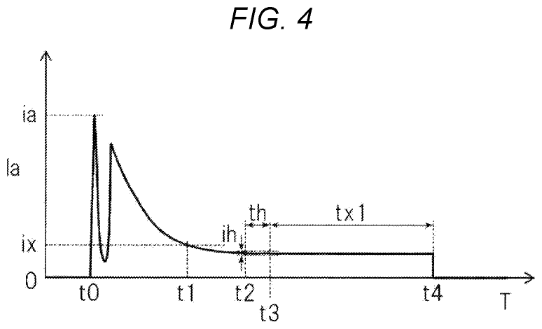

Operations of the first processing example of the release control will be described with reference to a time series diagram (changes in the state amount Ia with respect to the time T) of FIG. 4. A plus sign (+) of the energization amount Ia (for example, a current value) corresponds to the movement of the electric motor MT in the reverse rotation direction (as a result, the backward direction Hb of the linear motion member TD and the release direction Db of the lower end portion Pb of the parking lever). Although the permission condition of “Ia<ix” described above is provided in the diagram, this condition can be omitted.

When the parking switch SW is turned from the ON state to the OFF state, a negative voltage is applied to the electric motor MT at a time point t0 such that the electric motor MT rotates reversely. Accordingly, the energization to the electric motor MT is started. At least until a time point t1, the end member EN and the linear motion member TD are abutted against each other, and the tension is applied to the parking cable CB. Due to the reverse rotation of the electric motor MT, the tension on the parking cable CB is gradually decreased, and the energization amount Ia decreases.

At the time point t1, the energization amount Ia is less than the release amount ix. Here, the prohibited constant determination of the energization amount Ia is permitted. At a time point t2, it is determined that the energization amount Ia is constant for the first time (here, the constant state of the energization amount Ia is not yet continued). The fact that the energization amount Ia is constant is determined based on the fact that the energization amount Ia falls within the predetermined range ih (a determination amount that is a predetermined constant set in advance). In addition, the fact that the energization amount Ia is constant may also be determined based on the fact that a time change amount (time differential value) dI of the energization amount Ia is equal to or smaller than a determination change amount dx (a predetermined constant set in advance). At the time point t2, in the braking device DB, the brake linings BL and the brake drum BD (in particular, the inner circumferential surface Mn) are substantially not in contact with each other.

At a time point t3 when the determination time th (a constant set in advance) elapses after the time point t2, the constant state of the energization amount Ia is determined. That is, step S120 is satisfied. Since this time point t3, the calculation of the first duration time Tk1 (integration of a duration time) is started. At a time point t4 when the first predetermined time tx1 (a constant set in advance) elapses after the time point t3, the application of the negative voltage to the electric motor MT is stopped, and the energization is stopped. That is, the release control is ended, and the current value Ia is zero. Along with the end of the release control, the movement of the linear motion member TD is stopped. At this time, there is a gap between the linear motion member TD and the rotary member KT.

In a device of PTL 1, release control is ended based on an increase in the energization amount Ia when the linear motion member TD is abutted against a stopper or the like, whereas, in the release control of the electric parking brake device EP according to the disclosure, the release control is ended based on the time T after the energization amount Ia becomes constant. Therefore, components such as the stopper is not necessary, and thus a configuration of the device is simplified. In addition, when the parking brake instruction is issued again, the electric power for the electric motor MT to release the tightening (for example, a tightening force of the screws Oj and Mj) in the motion conversion mechanism HN when the linear motion member TD is abutted against the stopper or the like is not necessary. Therefore, power corresponding to a torque for releasing the tightening can be saved.

### <Second Processing Example of Release Control>

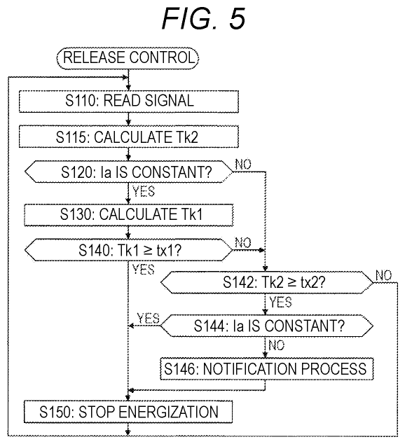

A second processing example of the release control will be described with reference to a flowchart of FIG. 5. For example, when a temperature is extremely low, viscosity of a lubricant (grease or the like) applied to the power transmission members (the speed reducer GS, the motion conversion mechanism HN, a bearing, and the like) may increase, and thus efficiency of the power transmission members may extremely decrease. In the second processing example of the release control, in such a situation, excessive return of the linear motion member TD is prevented. Specifically, although a stopper or the like (a member for restricting movement) in the backward direction Hb of the linear motion member TD is omitted in the electric parking brake device EP, contact between the linear motion member TD and the rotary member KT is reliably prevented in the second processing example. In the second processing example, processing steps denoted by the same reference numerals as in the first processing example perform the same calculation processes as in the first processing example.

In the second processing example, the release control is still started at the time point when the parking signal Sw is switched from ON to OFF. At this time point, the electric motor MT is energized (for example, a voltage is applied), and the electric motor MT is driven in the reverse rotation direction.

In step S110, the energization amount Ia is read. In step S115, a second duration time Tk2 is calculated. The second duration time Tk2 is a time from a release start time point (corresponding calculation cycle) of the parking brake. Here, the “release start time point” is a “time point when the instruction to release the parking brake is started”. For example, the time point is a time point when the parking switch SW is switched from the ON state to the OFF state (that is, a time point when an ON signal of the parking signal Sw transitions to an OFF signal). In addition, the “release start time point” may also be a “time point when the energization to the electric motor is started”. In this case, a parking brake control process is performed by a controller different from the controller ECU, and the controller ECU is instructed to start the energization to the electric motor MT through the communication bus BS. In any case, in step S115, the second duration time Tk2 is integrated and determined.

In step S120, it is determined “whether or not the energization amount Ia is constant (constant determination)”. As described above, the constant state of the energization amount Ia is determined at “the time point when the state in which the energization amount Ia falls within the predetermined range (the range of the determination amount ih) set in advance is continued for the determination time th” or “the time point when the state in which the time change amount dI of the energization amount Ia is equal to or smaller than the determination change amount dx is maintained for the determination time th”. Here, the determination amount ih, the determination time th, and the determination change amount dx are predetermined values (constants) set in advance. Similarly, in step S120, the permission condition that “the energization amount Ia is less than the release amount ix” may be adopted to improve the robustness of the constant determination. The release amount ix is set to a value slightly larger than the energization amount corresponding to no-load driving of the electric motor MT. In step S120, when the energization amount Ia is not constant, the process proceeds to step S142. On the other hand, when the energization amount Ia is constant, the process proceeds to step S130.

In step S130, the first duration time Tk1 is calculated. The first duration time Tk1 is the time from the time point (corresponding calculation cycle) when the determination in step S120 is affirmative for the first time, and the first duration time Tk1 is determined by sequentially integrating the time T with reference to the time point when the state in which the energization amount Ia is not constant is switched (transitioned) to the state in which the energization amount Ia is constant.

In step S140, it is determined “whether or not the first duration time Tk1 is equal to or longer than the first predetermined time tx1”. Here, the first predetermined time tx1 is a predetermined value (constant) set in advance. When “Tk1<tx1” and the determination in step S140 is negative, the process proceeds to step S142. On the other hand, when “Tk1≥tx1” and the determination in step S140 is affirmative, the process proceeds to step S150.

In step S142, it is determined “whether or not the second duration time Tk2 is equal to or longer than a second predetermined time tx2”. Here, the second predetermined time tx2 is a predetermined value (constant) set in advance. When “Tk2<tx2” and the determination of step S142 is negative, the process returns to step S110. On the other hand, when “Tk2≥tx2” and the determination of step S142 is affirmative, the process proceeds to step S144.

In step S144, it is determined “whether or not the energization amount Ia to the electric motor MT is constant (the constant determination, which is the same process as step S120)”. When the energization amount Ia is constant and the determination of step S144 is affirmative, the process proceeds to step S150. On the other hand, when the energization amount Ia is not constant and the determination in step S144 is negative, the process proceeds to step S146.

In step S146, notification to the driver is performed. This process is referred to as a “notification process”. By the notification process, the driver is notified of a state in which the electric parking brake device EP does not operate properly (for example, a decrease in efficiency of a power transmission mechanism). The notification is performed visually and/or audibly via the notification unit HC. After the notification process is performed, the process proceeds to step S150.

In step S150, the application of the voltage to the electric motor MT is stopped, and the energization is stopped. That is, the release control is ended, and the movement of the linear motion member TD in the backward direction Hb is stopped. As in the first processing example, at the time point when the release control is ended, there is a gap between the end portion Mk of the linear motion member TD and the portion Md of the rotary member KT. In the second processing example, the same effects (power saving, weight reduction, and size reduction) as those of the first processing example are still achieved.

Further, in the second processing example, when the energization to the electric motor MT is not stopped at the time point when the second predetermined time tx2 elapses after the release start time point of the parking brake (the time point when the release instruction is issued or the time point when the energization to the electric motor is started), the energization to the electric motor MT is stopped. That is, a time guard of the stop of the energization is provided by the time Tk2 after the release start time point of the parking brake (second duration time). Accordingly, excessive return of the linear motion member TD (for example, an insufficient gap between the linear motion member TD and the rotary member KT) caused by the increase in the viscosity of the lubricant at an extremely low temperature or the like is prevented. When such a situation occurs, the driver is notified of the situation through the notification unit HC.

### <Notification Process>

In the notification process, the process of step S144 (that is, the process of the constant determination) may be omitted. In this case, the notification to the driver is performed when the energization to the electric motor MT is stopped for the first time in response to the fact of “Tk2≥tx2” (referred to as a “condition of the second duration time”).

However, it is desirable to provide the process of step S144 in the notification process. That is, the notification to the driver is performed only when “the condition of the second duration time is satisfied” and “when the determination of the constant state of the energization amount Ia is negative at this time point (when the energization amount Ia is not constant)”. When the energization amount Ia is constant, a decrease in transmission efficiency or the like occurs whereas the contact between the brake linings BL and the brake drum BD is released. In this state, even if the vehicle moves after the release operation, the notification to the driver is not performed since brake drag is unlikely to occur. Since the notification is performed only when the determination of the certain conditions in step S144 is negative, unnecessary notification to the driver can be prevented.

Further, in step S144, a condition that “the energization amount Ia is less than a notification amount iy” may be provided. That is, in the notification process, the notification to the driver is performed “in a case where the condition of the second duration time is satisfied”, and in a case corresponding to at least one of “a case where the energization amount Ia is not constant” and “a case where the energization amount Ia is equal to or larger than the notification amount iy”. On the other hand, even in “the case where the condition of the second duration time is satisfied”, the notification to the driver is not performed only when “the energization amount Ia is constant” and “the energization amount Ia is less than the notification amount iy”. Here, the notification amount iy is a predetermined value (constant) set in advance, and can be set to a value slightly larger than an energization amount corresponding to a case where the electric motor MT is driven with no load (that is, sliding friction of the electric motor MT, the speed reducer GS, the rotary member KT, the linear motion member TD, the rotation stopping member MD, and the like). For example, the notification amount iy may be set to the same value as the release amount ix.

When the transmission efficiency decreases, the decrease gradient of the energization amount Ia with respect to the time T decreases, and the constant state of the energization amount Ia may be determined even in the state in which the brake linings BL are still in contact with the brake drum BD. In this situation, since brake drag may occur, it is desirable to perform the notification process. Therefore, “the case where the energization amount Ia is constant” and “the case where the energization amount Ia is less than the notification amount iy” may be adopted as a condition under which the notification process is not performed. As a result, robustness of the notification is improved, unnecessary notification is prevented, and necessary notification is reliably performed.

### <Operations of Second Processing Example>

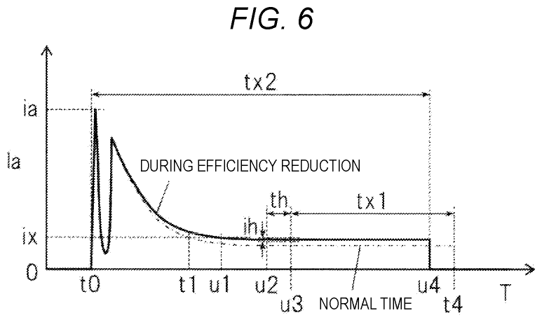

Operations of the second processing example of the release control will be described with reference to a time series diagram (changes in the energization amount Ia with respect to the time T) of FIG. 6. The diagram is assumed to be in a case where the efficiency of the power transmission members is extremely reduced at an extremely low temperature (referred to as “during efficiency reduction”). A situation in which the electric parking brake device EP properly operates at a normal temperature (denoted as “normal time”) is indicated by a dash-dotted line. Here, the time points t0, t1, and t4 respectively correspond to the time points t0, t1, and t4 in the time series diagram of FIG. 4. As in FIG. 4, a plus sign (+) of the energization amount Ia (for example, a current value) corresponds to the movement of the electric motor MT in the reverse rotation direction (as a result, the backward direction Hb of the linear motion member TD and the release direction Db of the lower end portion Pb of the parking lever). Although the permission condition of “Ia<ix” described above is provided in the diagram, this condition can be omitted.

At the time point to, the voltage starts to be applied to the electric motor MT such that the electric motor MT rotates reversely. Accordingly, the energization (power supply) to the electric motor MT is started. Here, the calculation (integration) of the second duration time Tk2 is started from the time point t0. The release start time point t0 is a time point when the release instruction of the parking brake is started (a time point when the parking signal Sw is switched from the ON state to the OFF state). Alternatively, the release start time point t0 may be a time point when the start of the energization to the electric motor is instructed. After the time point t0, the time T (calculation cycle) is sequentially integrated to calculate the second duration time Tk2.

Since the time point t0, the tension on the parking cable CB is gradually decreased due to the reverse rotation of the electric motor MT, and the energization amount Ia is decreased. Although “Ia<ix” is satisfied at the time point t1 at a normal temperature, since the efficiency of the power transmission members decreases and the above-described decrease gradient decreases, “Ia<ix” is achieved at a time point u1 after the time point t1. At the time point u1, “Ia<ix”, and the prohibited constant determination of the energization amount Ia is permitted.

At a time point u2, it is determined that the energization amount Ia is constant for the first time (here, the constant state of the energization amount Ia is not yet continued). At a time point u3 when the determination time th (a constant set in advance) elapses after the time point u2, the constant state of the energization amount Ia is determined. That is, step S120 is satisfied. Since this time point u3, the calculation of the first duration time Tk1 (the integration of the duration time) is started.

Immediately before a time point u4, since the first duration time Tk1 does not reach the first predetermined time tx1 yet, the electric motor MT is continuously energized. At the time point u4, the second duration time Tk2 reaches the second predetermined time tx2. Accordingly, the condition in step S140 is satisfied, the application of the negative voltage to the electric motor MT is stopped, and the energization is stopped (the current value Ia is zero). That is, the release control is ended, and the movement of the linear motion member TD is stopped. For example, in a case where the second duration time Tk2 is not adopted, the energization is stopped at the time point t4 (the time point when the first predetermined time tx1 elapses after the time point u3), whereas the energization is stopped at the time point u4 prior to (earlier than) the time point t4 by adopting the second duration time Tk2. That is, the time guard is provided by the second duration time Tk2 when returning the linear motion member TD, and thus the energization to the electric motor MT is stopped early. In the assumed situation, since it is determined in step S144 that the energization amount Ia is constant, the notification process is not performed at the time point u4.

When the efficiency of the power transmission members decreases, the constant determination is delayed. When the release control is determined only based on the first duration time Tk1, the linear motion member TD may be excessively returned. In order to prevent this situation, a condition (time guard process) related to the second duration time Tk2 is adopted. Specifically, at a time point when at least one of “the first duration time Tk1 is equal to or longer than the first predetermined time tx1” and “the second duration time Tk2 is equal to or longer than the second predetermined time tx2” is satisfied, the release control is ended and the energization to the electric motor MT is stopped. That is, even in a situation where “Tk1≥tx1” is not satisfied while the linear motion member TD is returned in the backward direction Hb, the energization to the electric motor MT is stopped when “Tk2≥tx2” is satisfied. In the second processing example, in addition to the effects of the first processing example (power saving, size reduction, and weight reduction of the device), the excessive return (excessive movement in the backward direction Hb) of the linear motion member TD is prevented, and thus contact between the linear motion member TD and the rotary member KT can be reliably prevented.

### OTHER EMBODIMENTS

Hereinafter, other embodiments of the electric parking brake device EP will be described. In the other embodiments, the same effects as those described above are still obtained.

In the above embodiment, the operation (application operation/release operation) of the electric parking brake device EP in response to the operation on the parking switch SW has been described. The application/release (operation) of the electric parking brake device EP may also be automatically performed instead of the operation on the parking switch SW. A situation in which the operation of the electric parking brake device EP is automatically performed is referred to as an “automatic mode”. In the automatic mode, for example, when the vehicle stops, the electric parking brake device EP automatically operates in the application operation (that is, the application control is executed), and the parking braking force Fp is generated (applied). In addition, when the driver operates the acceleration operation member (the accelerator pedal or the like) and the operation amount Ap increases from “0 (zero)”, the electric parking brake device EP can automatically operates in the release operation (that is, the release control is executed). The automatic mode is executed based on the vehicle body speed Vx and the acceleration operation amount Ap acquired by the controller ECU via the communication bus BS.

In a vehicle provided with an automatic braking device, the automatic mode of the electric parking brake device EP may be executed without any operation performed by the driver. For example, the vehicle body speed Vx is automatically adjusted upon detecting a preceding vehicle so as to assist driving at the time of traffic congestion or the like. When the preceding vehicle stops, the vehicle automatically stops while maintaining an inter-vehicle distance, and the electric parking brake device EP automatically operates in the application operation. Thereafter, when the preceding vehicle starts, the electric parking brake device EP automatically operates in the release operation, and the vehicle body speed Vx of the vehicle is adjusted so as to follow the preceding vehicle.

1. An electric parking brake device comprising:
a linear motion member configured to be driven by an electric motor, moved in a forward direction so as to apply a parking brake and moved in a backward direction opposite to the forward direction so as to release the parking brake; and
a controller configured to control the electric motor, wherein
when the parking brake is released, the controller stops energization to the electric motor at a time point when a first predetermined time elapses after a time point when an energization amount to the electric motor becomes constant.

2. The electric parking brake device according to claim 1, wherein
when the energization to the electric motor is not stopped at a time point when a second predetermined time elapses after a time point when the release of the parking brake is started, the controller stops the energization.

3. The electric parking brake device according to claim 2, wherein
when the energization to the electric motor is stopped for a first time at the time point when the second predetermined time elapses, the controller notifies the driver.

4. The electric parking brake device according to claim 3, wherein
when the energization amount to the electric motor becomes constant, the controller does not perform the notification.
